(19) United States
(12) Patent Application Publication
(10) Pub. No.: US 2009/0242732 A1
(43) Pub. Date: Oct. 1, 2009

(54) Apparatus for making ice glasses, bowls and candleholders

(76) Inventor: Tamar Garmizo, Tel Aviv (IL)

Correspondence Address: TAMAR GARMIZO, P.O. Box 29746, TEL AVIV, 61297, IL

(21) Appl. No.: 12/079,066

(22) Filed: Mar. 25, 2008

(51) Int. Cl. F25C 1/22; B29C 33/42

(52) U.S. Cl. 249/204; 249/187.1

(57) ABSTRACT

A one-piece apparatus for making ice glasses using a regular glass. The apparatus is shaped like a cylindrical nipple with a dome-shaped head that gradually widens until it turns into a round base with a protruding rim around its circumference. The apparatus is used with a regular glass with a uniform rim, and the freezing action takes place with the regular glass upside down. Use of the apparatus is simple and efficient. First, a regular glass is filled with water. Then the apparatus is inserted into the regular glass so that the nipple is facing the bottom of the glass. Next, the regular glass is turned upside down, with the apparatus in it, and placed in the freezer. After the water has frozen, the apparatus and the regular glass are separated and an ice glass is obtained.

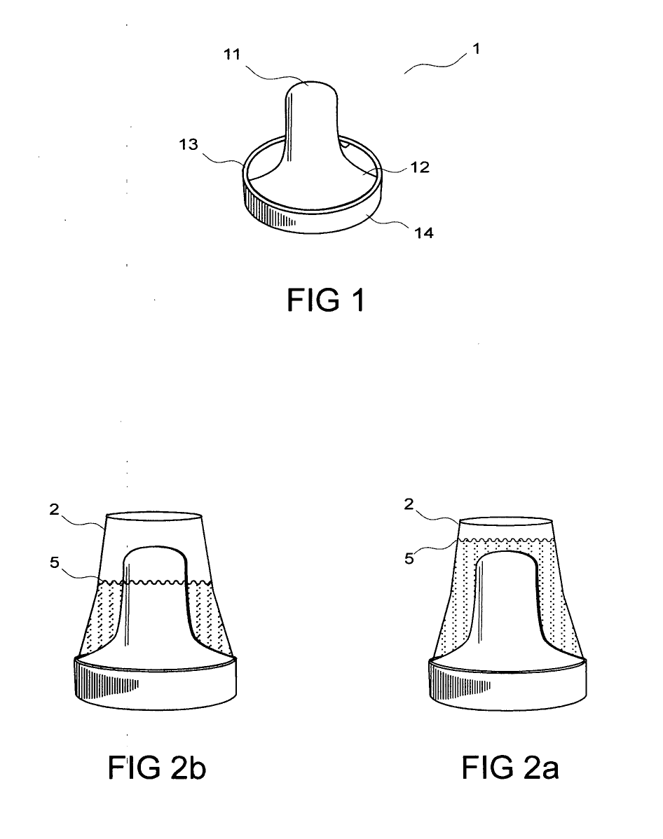

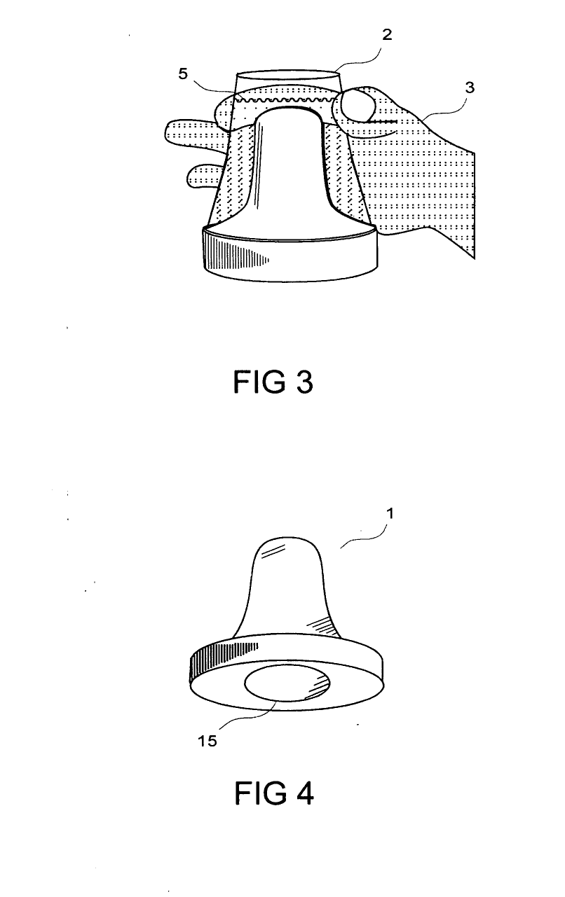

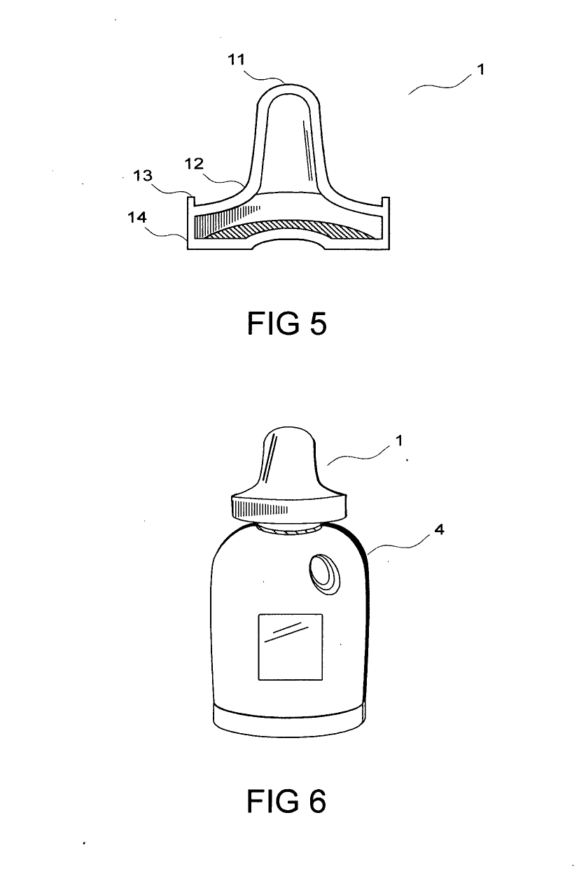

### TECHNICAL FIELD

The present invention refers to an apparatus for making ice glasses, bowls and candleholders.

### BACKGROUND ART

On certain occasions, such as parties and other events, hosts or guests or the general public wish to use glasses or bowls that are made of ice, mainly for serving alcoholic beverages, ice creams, fruit salad and so on. The use of glasses and bowls made of ice is a decorative gimmick for any event. In addition, in many cases, and as part of the event's decoration scheme, there is a desire and interest to use ice candleholders in which lit candles are placed.

The present invention is an apparatus for making ice glasses, bowls and candleholders. For the sake of fluency, the expression “ice glass” refers, in this application, to a glass or bowl or candleholder, according to the context.

### THE INVENTION

(The numbers in parentheses refer to the corresponding numbers in the drawings)

The present invention refers to an apparatus (1) for making ice glasses, bowls and candleholders. The apparatus (1) is depicted in Drawing No. 1 and is shaped like a cylindrical nipple with a round base. The upper part of the apparatus is shaped like a cylindrical nipple (11) with a dome-shaped head. The nipple (11) gradually become wider towards the base (12) of the apparatus (1). The base (12) of the apparatus (1) has a raised lip (13), which constitutes the upper edge of the side (14) of the base (12). The apparatus (1) is round and symmetrical, as depicted in the drawings.

Drawings Nos. 2a, 2b and 3 depict the mode of use of the apparatus. To made an ice glass, use is made of some kind of regular glass (possibly even a disposable plastic, foam, or paper cup).

The steps for using the apparatus are as follows: (a) The glass (2) is first filled with water, but preferably not to the rim, for reasons explained later on in the application. (b) After filling the glass (2) with water, the apparatus (1) is inserted into the glass (2) so that the nipple (11) faces the bottom of the glass (2). (c) Then, the glass (2) is turned upside down so that the rim of the glass (2) faces down, and the nipple (11) now faces up. To execute this step properly, the glass (2) and the apparatus (1) must be held in the hands or fingers of one hand so they are tightly connected and joined to one another, and pressure is applied on them both in order to keep them tightly connected and joined. (d) The glass (2), into which the apparatus (1) was inserted, is now in “freezing mode” and is placed in the freezer. (e) After the water in the glass has frozen and has become ice, the glass (2) and the apparatus (1) are removed from the freezer and separated, so that the water that was in the glass [in the space between the glass (2) and the apparatus (1)], and which is now ice, is shaped like glass made of ice.

The final shape of the ice glass is determined by the shape of the apparatus (1) and of the glass (2). In other words, the exterior shape of the ice glass is determined by the interior shape of the glass (2) whereas the interior shape of the ice glass is determined by the exterior shapes of the nipple (11) and base (12) of the apparatus (1).

When the water level (5) in the glass (2) in freezing mode is higher than the tip of the nipple (11), as depicted for instance in Drawing No. 2a, then the ice will be shaped like a glass. When the water level (5) is lower than the tip of the nipple (11), as depicted for instance in Drawing No. 2b, then the ice will be shaped like a hollow cylinder that can serve as a candleholder in which a lit candle can be placed. Candleholders commonly used today are made of glass or any other material and are usually transparent or semi-transparent. Such candleholders are cylindrical, with closed bottoms and open tops, and candles can be placed in them. Light from the candle reflects through the sides of the candleholder, which, as mentioned, is made of glass or of a transparent or semi-transparent material. When the invention is implemented as a candleholder, the ice is not impermeable to light and therefore light from the candle can reflect through the ice candleholder, and the more the ice melts and the wall grows thinner, the more intense will be the reflection of the candle's light. The candleholder should be open at the bottom to enable the melted water to drain. The candleholder should also be placed in a matching bowl to collect the said water.

The base (12) of the apparatus (1) is uniform so as to fit any rim of any kind of glass (2), provided the rim of the glass (2) is uniform (in height).

The apparatus (1) can be used to make ice glasses from all kinds of glasses (2), due to the fact that the base (12) of the apparatus (1) slopes in such a way that it fits any diameter of any glass (2), provided the diameter of the glass (2) is smaller than the diameter of the rim (13).

When the glass (2) is filled with water, as mentioned above, it must not be filled to the rim for several reasons. First, when the apparatus (1) is in freezing mode, air remains in the space between the bottom of the glass (2) and the top of the apparatus, as depicted for instance in Drawing No. 3. This creates vacuum and enables the apparatus (1) to remain tightly connected and joined to the glass (2), even when upside down [in freezing mode], as depicted for instance in Drawing No. 3. Second, during freezing, the water expands into the said space and does not apply pressure on the glass (2) or apparatus (1).

The fact that the apparatus is designed so that it is used in freezing mode [the glass (2) is upside down] enables to made ice glasses with smooth and uniform rims, which is the preferred form.

A hole (15) may be added at the bottom of the apparatus (1), and in general, the apparatus (1) may be manufactured hollow, both so as to enable stacking of several apparatuses for storage, and to enable the apparatus to be used to cover a beverage bottle (4), as depicted for instance in Drawing No. 6.

The apparatus (1) can be made from any material, although it is the inventor's experience that the apparatus should preferably be made from a soft and flexible material, such as rubber or silicon so that when the ice expands, it compresses the body of the apparatus and thus prevents cracks in the ice itself.

In order to use the ice glasses more efficiently, they should be held in a holder, similar to metal holders used to hold hot beverage glasses made of glass. Holders can be made of metal or plastic or any other material. In order to improve the aesthetics, the glass holder can be illuminated from the bottom so that the light is projected into the ice, thus adding a color effect to the invention.

The advantages of the apparatus (1) for making ice glasses are many, and include: (a) The apparatus constitutes a single unit rather than a number of integrated units. (b) The apparatus is suitable for use with almost any glass found in any standard kitchen. (c) The apparatus makes ice glasses with a smooth and uniform rim.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

The drawings attached to the application are not intended to limit the scope of the invention and the possible ways of its application. The drawings are intended only to illustrate the invention and constitute only one of many possible ways of its application.

Drawing No. 1: Drawing No. 1 depicts the apparatus (1) including the nipple (11), base (12), rim (13), and side (14).

Drawing No. 2: Drawing No. 2a depicts the apparatus (1) in freezing mode, whereby it is tightly joined to a regular glass (2), which is filled with water to a level (5) that is higher than the tip of the apparatus's nipple. Drawing No. 2b depicts the same situation as depicted in Drawing No. 2a but the water level (5) is lower than the tip of the apparatus's nipple.

Drawing No. 3: Drawing No. 3 depicts the apparatus (1) in freezing mode, whereby it is tightly joined to a regular glass (2), which is filled with water to a level (5) that is higher than the tip of the apparatus's nipple. The glass (2) is held by hand so that the apparatus does not become separated from the glass.

Drawing No. 4: Drawing No. 4 depicts the apparatus (1), including a hole (15) in its bottom part.

Drawing No. 5: Drawing No. 5 depicts a longitudinal section of the hollow apparatus (1), including the nipple (11), base (12), rim (13), and side (14).

Drawing No. 6: Drawing No. 6 depicts the apparatus used to cover a bottle (4).

What is claimed is:

1. An apparatus for making glasses made of ice, that is shaped like a nipple with a round base and is designed to be used with a regular glass with a uniform rim, so that freezing can take place with the regular glass upside down.

2. The apparatus mentioned in claim No. 1, whereby the nipple is cylindrical with a dome-shaped head that gradually widens towards the base, which is round and uniform.

3. The apparatus mentioned in claim No. 1, which is round and symmetrical.

4. The apparatus mentioned in claim No. 1, whereby the circumference of the base has a protruding rim.
